(19) United States
(12) Patent Application Publication
(10) Pub. No.: US 2007/0065600 A1
(43) Pub. Date: Mar. 22, 2007

(54) Barrier coating composition containing a liquid crystalline polymer as well as a device containing this barrier coating composition

(76) Inventor: Robert Hammond-Smith, Hampshire (GB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/576,011

(22) PCT Filed: Sep. 16, 2004
(86) PCT No.: PCT/EP04/10397

§ 371 Date: Apr. 17, 2006

(30) Foreign Application Priority Data
Oct. 18, 2003 (EP) 03023462.9

(51) Int. Cl. C09K 19/00; B32B 1/08

(52) U.S. Cl. 428/1.1; 428/35.7; 428/35.2

(57) ABSTRACT

The present invention relates to a barrier coating composition comprising a liquid crystalline polymer, which is characterized in that the liquid crystalline polymer is formed in that a polymerizable liquid crystalline mixture comprising one or more polymerizable mesogenic compounds is first applied onto a substrate and polymerized afterwards, a method of its preparation, its use as well as to devices, preferably displays, food and medical packagings each having at least one barrier coating layer comprising a barrier coating composition of the present invention.

### FIELD OF THE INVENTION

The present invention relates to a barrier coating composition containing a liquid crystalline polymer which is prepared from polymerizable mesogenic compounds. This barrier coating composition can be used in Organic Field effect transistors, Liquid crystal displays, OLED displays, flexible displays, displays of TV screens, photovoltaic cells, lithium batteries, food packaging, medical packaging and any other application requiring a barrier against water and/or oxygen.

Furthermore, the present invention relates to a device, preferably a display, containing such a barrier coating composition as well as their fabrication processes. The display is particularly suitable for Liquid crystal displays, OLED displays, displays of TV screens and other flexible displays.

### PRIOR ART

Devices, such as Organic Field effect transistors, Liquid crystal displays, OLED displays, flexible displays, photovoltaic cells and lithium batteries, normally contain reactive organic materials. Unfortunately, these reactive organic materials are susceptible to water and/or oxygen. Therefore, these devices need to have a barrier coating to allow an efficient, long-term operation.

At the present glass sheets or metal casings are primarily used as barrier layers to prevent the egress of water and/or oxygen. Nevertheless, the use of glass and metal causes weight and rigidity problems.

Instead of glass and metal, more recently laminated sheets comprising alternate layers of polyethyleneterephthalate (PET) or polynaphthaleneterephthalate (PEN) and an inorganic material such as silica, alumina or silicon nitride have been used. Such a material is e.g. Barix®, sold by Vitex. The disadvantage of these laminated sheets is that they are opaque and/or require several stages of vacuum deposition to build up the required structure. For display applications transparent coatings and easier solution based processes are required.

Medical and food packagings are commonly produced by extruding or co-extruding polymeric materials such as PET or PEN. These are sometimes covered with a layer of metal, such as aluminium, to provide improved barrier properties.

Also the use of liquid crystalline polymers have been reported in the manufacture of medical supplies and other plastic components requiring a high degree of protection.

Liquid crystalline polymer film structures comprising either two relatively thin outer surface portions which are oriented in a first controllable direction, and a relatively thick inner portion oriented in at least a second controllable direction and possibly in a third controllable direction or two outer surface layers which are oriented generally in a first controllable direction, two intermediate layers respectively inward of said outer surface layers which are oriented generally in a second controllable direction, and a central core layer sandwiched between said middle layers which is oriented generally in a third controllable direction, are disclosed in U.S. Pat. No. 5,288,529.

A composite material, comprising an anisotropic, thermotropic liquid-crystalline polymer matrix and/or a mixture of liquid-crystalline polymer(s) and thermoplastic polymer reinforced with fibrous reinforcing units, which is characterized in that the reinforcing fibers are continuous carbon fibers, is disclosed in WO 94/29386 A1.

A multilayer polymeric barrier material comprising (1) a first sandwich polymer layer, (2) at least one sandwiched, oriented liquid crystalline polymer layer, and (3) a second sandwich polymer layer, the first and second sandwich layers disposed to sandwich the liquid crystalline layer therebetween, is disclosed in U.S. Pat. No. 6,179,818 B1.

The drawbacks of these liquid crystalline polymers are that, due to their polymer structure, on one hand their processing and on the other hand the complete orientation of all chain units is very difficult.

### Problems to be Solved

Therefore, it was an aim of the present application to develop a barrier coating composition which exhibits:
the required barrier properties,
the required clarity,
the required flexibility,
a low weight, and
which should be very easy processable.

Another aim of the present application was to provide a process for the preparation of the barrier coating composition. Preferably, the barrier coating composition should be solution processable, more preferably solution processable in a single step reel to reel process.

A further aim of the present application was to provide a barrier coating composition which can be used in Organic Field effect transistors, Liquid crystal displays, OLED displays, flexible displays, displays of TV screens, photovoltaic cells and lithium batteries, as well as in food and medical packagings and any other application that requires a barrier against water and/or oxygen.

### THE PRESENT INVENTION

Surprisingly it has been found that it is possible to achieve very good barrier properties, if a liquid crystalline polymer is used as a barrier coating composition, which is prepared in that a polymerizable liquid crystalline mixture comprising one or more polymerisable mesogenic compounds is first brought in form and polymerised afterwards.

Therefore, according to the present invention there is provided a barrier coating composition comprising a liquid crystalline polymer, which is characterized in that the liquid crystalline polymer is formed in that a polymerizable liquid crystalline mixture comprising one or more polymerizable mesogenic compounds is first applied onto a substrate and polymerized afterwards.

As polymerizable mesogenic compounds all mesogenic materials which are polymerizable and which are known to a person skilled in the art can be used.

The term ‘mesogenic compounds’ as used in the foregoing and the following should denote compounds with a rod-shaped, lath-shaped or disk-shaped mesogenic group, i.e. a group with the ability to induce mesophase behaviour. These compounds do not necessarily have to exhibit mesophase behaviour by themselves. It is also possible that these compounds show mesophase behaviour only in mixtures with other compounds or when the mesogenic compounds or the mixtures comprising them are polymerized. Rod-shaped and lath-shaped mesogenic groups are especially preferred.

### PREFERRED EMBODIMENTS OF THE PRESENT INVENTION

The polymerizable mesogenic compounds of the polymerizable liquid crystalline mixture are preferably selected of formula I
P-(Sp-X)ₙ-MG-R I
wherein
P is a polymerizable group,
Sp is a spacer group having 1 to 25 C atoms,
X is —O—, —S—, —CO—, —COO—, —OCO—, —CO—NH—, —NH—CO—, —CH₂CH₂—, —OCH₂—, —CH₂O—, —SCH₂—, —CH₂S—, —CH═CH—, —CH═CH—COO—, —OCO—CH═CH—, —C≡C— or a single bond,
n is 0 or 1,
MG is a mesogenic group, and
R is H, CN, NO₂, halogen or a straight-chain or branched alkyl radical with up to 25 C atoms which may be unsubstituted, mono- or polysubstituted by halogen or CN, it being also possible for one or more non-adjacent CH₂ groups to be replaced, in each case independently from one another, by —O—, —S—, —NH—, —N(CH₃)—, —CO—, —COO—, —OCO—, —OCO—O—, —S—CO—, —CO—S— or —C≡C—, in such a manner that oxygen atoms are not linked directly to one another, or alternatively R is denoting P-(Sp-X)ₙ—.
MG in formula I is preferably selected of formula II
   -A¹-Z¹-(A²-Z²-)ₘ-A³- II
   wherein
Z¹ and Z² are each independently —COO—, —OCO—, —CH₂CH₂—, —OCH₂—, —CH₂O—, —CH═CH—, —CH═CH—COO—, —OCO—CH═CH—, —C≡C— or a single bond,
A¹, A² and A³ are each independently 1,4-phenylene in which, in addition, one or more CH groups may be replaced by N, 1,4-cyclohexylene in which, in addition, one or two non-adjacent CH₂ groups may be replaced by O and/or S, 1,4-cyclohexenylene, 1,4-bicyclo(2,2,2)octylene, piperidine-1,4-diyl, naphthalene-2,6-diyl, decahydronaphthalene-2,6-diyl or 1,2,3,4-tetrahydronaphthalene-2,6-diyl, it being possible for all these groups to be unsubstituted, mono- or polysubstituted with F, Cl, OH, CN, NO₂ or alkyl, alkoxy or alkanoyl groups having 1 to 7 C atoms wherein one or more H atoms may be substituted by F or Cl, and
m is 0, 1 or 2.

A smaller group of preferred mesogenic groups of formula II is listed below. For reasons of simplicity, Phe in these groups is 1,4-phenylene, PheL is a 1,4-phenylene group which is substituted by 1 to 4 groups L, with L being F, Cl, CN, OH, NO₂ or an optionally fluorinated or chlorinated alkyl, alkoxy or alkanoyl group with 1 to 7 C atoms, and Cyc is 1,4-cyclohexylene. The following list of preferred mesogenic groups is comprising the subformulae II-1 to II-25 as well as their mirror images
-Phe-Z-Phe- II-1
-Phe-Z-Cyc- II-2
-Cyc-Z-Cyc- II-3
-PheL-Z-Phe- II-4
-PheL-Z-Cyc- II-5
-PheL-Z-PheL- II-6
-Phe-Z-Phe-Z-Phe- II-7
-Phe-Z-Phe-Z-Cyc- II-8
-Phe-Z-Cyc-Z-Phe- II-9
-Cyc-Z-Phe-Z-Cyc- II-10
-Phe-Z-Cyc-Z-Cyc- II-11
-Cyc-Z-Cyc-Z-Cyc- II-12
-Phe-Z-Phe-Z-PheL- II-13
-Phe-Z-PheL-Z-Phe- II-14
-PheL-Z-Phe-Z-Phe- II-15
-PheL-Z-Phe-Z-PheL- II-16
-PheL-Z-PheL-Z-Phe- II-17
-PheL-Z-PheL-Z-PheL- II-18
-Phe-Z-PheL-Z-Cyc- II-19
-Phe-Z-Cyc-Z-PheL- II-20
-Cyc-Z-Phe-Z-PheL- II-21
-PheL-Z-Cyc-Z-PheL- II-22
-PheL-Z-PheL-Z-Cyc- II-23
-PheL-Z-Cyc-Z-Cyc- II-24
-Cyc-Z-PheL-Z-Cyc- II-25

Particularly preferred are the subformulae II-1, II-2, II-4, II-6, II-7, II-8, II-11, II-13, II-14, II-15 and II-16.

In these preferred groups Z in each case independently has one of the meanings of Z¹ as given in formula I. Preferably Z is —COO—, —OCO—, —CH₂CH₂—, —C≡C— or a single bond.

Very preferably the mesogenic group MG is selected from the following formulae and their mirror images 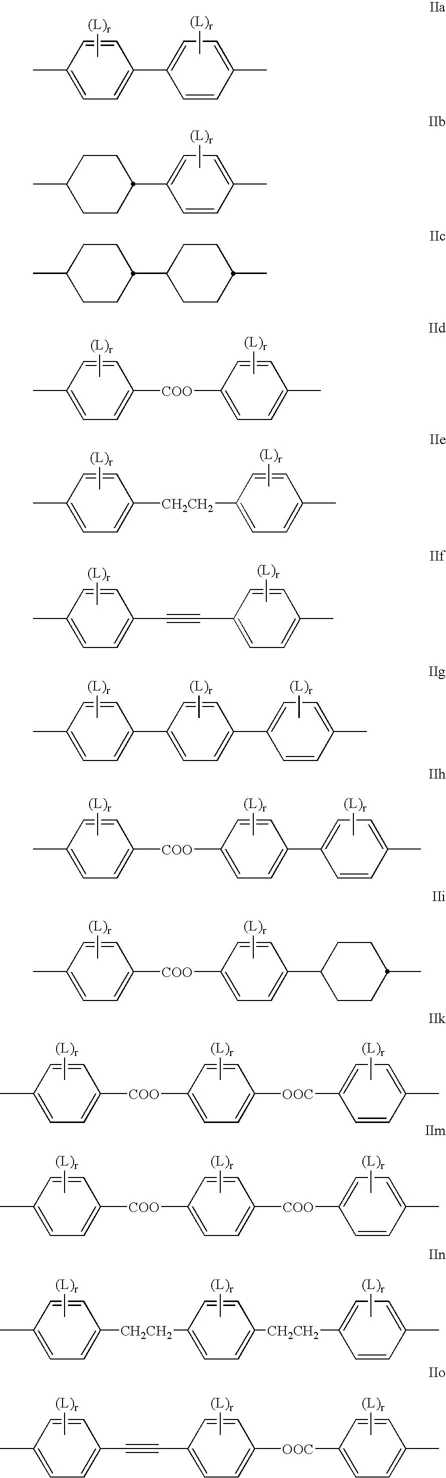
wherein L has the meaning given above and r is 0, 1 or 2.

The group 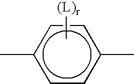
in these preferred formulae is more preferably denoting 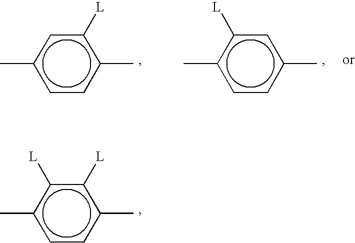
furthermore 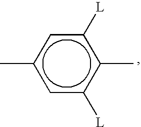
with L having each independently one of the meanings given above.

Particularly preferred are the subformulae IId, IIg, IIh, IIi, IIk and IIo, in particular the subformulae IId and IIk.

L is preferably F, Cl, CN, OH, NO₂, CH₃, C₂H₅, OCH₃, OC₂H₅, COCH₃, COC₂H₅, COOCH₃, COOC₂H₅, CF₃, OCF₃, OCHF₂, OC₂F₅, more preferably F, Cl, CN, CH₃, C₂H₅, OCH₃, COCH₃ and OCF₃, in particular F, Cl, CH₃, OCH₃ and COCH₃.

In another embodiment the polymerizable liquid crystalline mixture comprises at least one chiral polymerizable compound of formula I comprising a mesogenic group having at least one center of chirality.

In these compounds M¹ and/or M² are preferably selected according to the following formulae
-(A¹-Z)ₐ-G¹- II*-1
-(A¹-Z)ₐ-G²-(Z-A²)_{b}- II*-2
wherein

A¹ and A² have the meaning given in formula II,

Z has the meaning of Z¹ given in formula II,

a and b are independently of each other 0, 1 or 2,

G¹ together with R in formula I forms a terminal chiral group, and

G is a bivalent chiral group.

Preferred chiral groups G¹-R are for example cholesteryl, terpenoid radicals as disclosed e.g. in WO 96/17901, preferably selected from menthyl, neomenthyl, campheyl, pineyl, terpineyl, isolongifolyl, fenchyl, carreyl, myrthenyl, nopyl, geraniyl, linaloyl, neryl, citronellyl and dihydrocitronellyl, more preferably menthyl or menthone derivatives or terminal chiral sugar derivatives comprising a mono- or bicyclic radical with pyranose or furanose rings like, for example, a group derived from the chiral sugars disclosed in WO 95/16007.

Preferred chiral groups G² are for example cholesteryl or groups derived from sugars, binaphthyl derivatives, or optically active glycols, especially ethane-1,2-diol substituted in 1- and or 2-position with alkyl or aryl groups. In case of sugar groups, these are preferably selected from mono- and dicyclic groups comprising pentose or hexose rings.

More preferably are the following groups G² 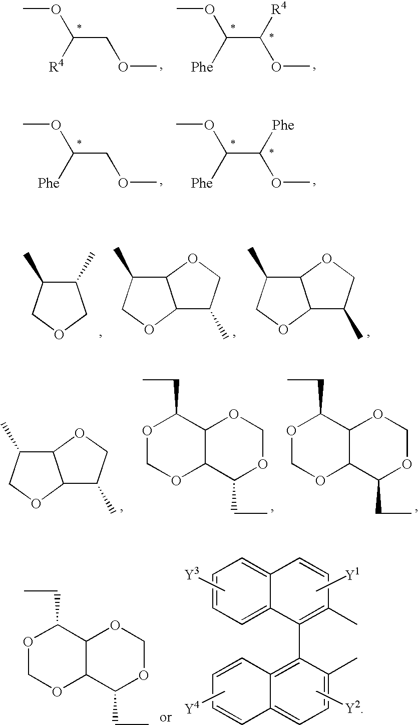
wherein Phe has the meaning given above, R⁴ is F or optionally fluorinated alkyl with 1 to 4 C atoms and Y¹, Y², Y³ and Y⁴ have one of the meanings of R in formula I.

In particular G² is dianhydrosorbitol, substituted ethane diol like 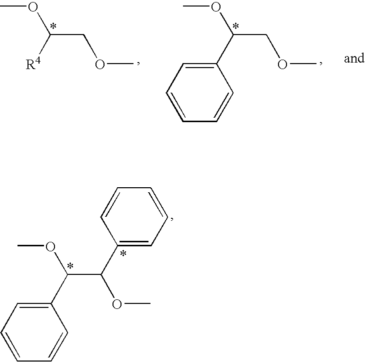
wherein R⁴ is F, CH₃ or CF₃, 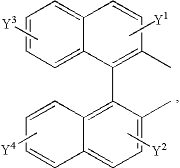
or optionally substituted binaphthyl
wherein Y¹, Y², Y³ and Y⁴ are H, F or optionally fluorinated alkyl with 1 to 8 C atoms.

Preferably -(A¹-Z)ₐ- and -(Z-A²)_{b}- in formula II*-1 and II*-2 are selected of the above disclosed preferred formulae II-1 to II-25 and IIa to IIo, more preferably of formulae II1 to II6 and IIa to IIf.

In case of polymerizable mesogenic compounds with a non-polar group, R is preferably alkyl with up to 15 C atoms, alkoxy with 2 to 15 C atoms or oxaalkyl with 2 to 9 C atoms.

If R is an alkyl or alkoxy radical, i.e. where the terminal CH₂ group is replaced by —O—, this may be straight-chain or branched. It is preferably straight-chain, has 2, 3, 4, 5, 6, 7 or 8 carbon atoms and accordingly is preferably ethyl, propyl, butyl, pentyl, hexyl, heptyl, octyl, ethoxy, propoxy, butoxy, pentoxy, hexoxy, heptoxy or octoxy, furthermore methyl, nonyl, decyl, undecyl, dodecyl, tridecyl, tetradecyl, pentadecyl, nonoxy, decoxy, undecoxy, dodecoxy, tridecoxy, tetradecoxy or pentadecoxy.

If R is an oxaalkyl radical, i.e. where one CH₂ group is replaced by —O—, it is preferably straight-chain 2-oxapropyl(=methoxymethyl), 2-(=ethoxymethyl) or 3-oxabutyl(=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl or 2-, 3-, 4-, 5-, 6-, 7-, 8- or 9-oxadecyl.

In case of polymerizable mesogenic compounds with a terminal polar group, R is selected from CN, NO₂, halogen, OCH₃, OCN, SCN, COR¹, COOR¹ or a mono-, oligo- or polyfluorinated alkyl or alkoxy group with 1 to 4 C atoms. R¹ is optionally fluorinated alkyl with 1 to 4, preferably 1 to 3 C atoms. Halogen is preferably F or Cl. Preferably in these compounds R is selected from F, Cl, CN, NO₂, OCH₃, COCH₃, COC₂H₅, COOCH₃, COOC₂H₅, CF₃, C₂F₅, OCF₃, OCHF₂ and OC₂F₅, in particular from F, Cl, CN, OCH₃ and OCF₃.

In the compounds of formula I R may be an achiral or a chiral group. In case of a chiral group it is preferably selected according to the following formula III: 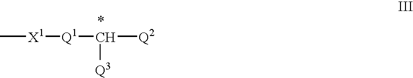
wherein
X¹ is —O—, —S—, —CO—, —COO—, —OCO—, —OCOO— or a single bond,
Q¹ is an alkylene or alkylene-oxy group with 1 to 10 C atoms or a single bond,
Q² is an alkyl or alkoxy group with 1 to 10 C atoms which may be unsubstituted, mono- or polysubstituted by halogen or CN, it being also possible for one or more non-adjacent CH₂ groups to be replaced, in each case independently from one another, by —C≡C—, —O—, —S—, —NH—, —N(CH₃)—, —CO—, —COO—, —OCO—, —OCO—O—, —S—CO— or —CO—S—, in such a manner that oxygen atoms are not linked directly to one another,
Q³ is halogen, a cyano group or an alkyl or alkoxy group with 1 to 4 C atoms different from Q².

In case Q¹ in formula III is an alkylene-oxy group, the O atom is preferably adjacent to the chiral C atom.

Preferred chiral groups R are 2-butyl(=1-methylpropyl), 2-methylbutyl, 2-methylpentyl, 3-methylpentyl, 2-ethylhexyl, 2-propylpentyl, 2-octyl, 2-methylbutoxy, 2-methylpentoxy, 3-methylpentoxy, 2-ethylhexoxy, 1-methylhexoxy, 2-octyloxy, 2-oxa-3-methylbutyl, 3-oxa4-methylpentyl, 4-methylhexyl, 2-nonyl, 2-decyl, 2-dodecyl, 6-methoxyoctoxy, 6-methyloctoxy, 6-methyloctanoyloxy, 5-methylheptyloxycarbonyl, 2-methylbutyryloxy, 3-methylvaleryloxy, 4-methyl hexanoyloxy, 2-chloropropionyloxy, 2-chloro-3-methylbutyryloxy, 2-chloro-4-methylvaleryloxy, 2-chloro-3-methylvaleryloxy, 2-methyl-3-oxapentyl, 2-methyl-3-oxahexyl, 1-methoxypropyl-2-oxy, 1-ethoxypropyl-2-oxy, 1-propoxypropyl-2-oxy, 1-butoxypropyl-2-oxy, 2-fluorooctyloxy and 2-fluorodecyloxy, in particular 2-methylbutyl.

In addition, compounds of formula I containing an achiral branched group R may occasionally be of importance, for example, due to a reduction in the tendency towards crystallization. Branched groups of this type generally do not contain more than one chain branch. Preferred achiral branched groups are isopropyl, isobutyl(=methylpropyl), isopentyl(=3-methylbutyl), isopropoxy, 2-methyl-propoxy and 3-methylbutoxy.

Another preferred embodiment of the present invention relates to compounds of formula I wherein R denotes P-(Sp-X)ₙ—.

The polymerizable group P in formula I is preferably selected from CH₂═CW¹—COO—, 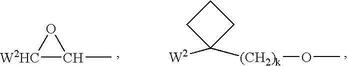
CH₂═CW²—O—, CH₃—CH═CH—O—, HO—CW²W³—, HS—CW²W³—, HW²N—, HO—CW²W³—NH—, CH₂═CW¹—CO—NH—, CH₂═CH—(COO)ₖ₁-Phe-(O)ₖ₂—, Phe-CH═CH—, HOOC—, OCN— and W⁴W⁵W⁶Si—, with W¹ being H, Cl, CN, phenyl or alkyl with 1 to 5 C-atoms, in particular H, Cl or CH₃, W² and W³ being independently of each other H or alkyl with 1 to 5 C-atoms, in particular methyl, ethyl or n-propyl, W⁴, W⁵ and W⁶ being independently of each other Cl, oxaalkyl or oxacarbonylalkyl with 1 to 5 C-atoms, Phe being 1,4-phenylenek is an integer from 1 to 12 and k₁ and k₂ being independently of each other 0 or 1.

More preferably P is an acrylate group, a methacrylate group, a vinyloxy group or an epoxy group, in particular an acrylate or epoxy group.

As for the spacer group Sp in formula I all groups can be used that are known for this purpose to the person skilled in the art. The spacer group Sp is preferably a linear or branched alkylene group having 1 to 20 C atoms, in particular 1 to 12 C atoms, in which, in addition, one or more non-adjacent CH₂ groups may be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—.

Typical spacer groups are for example —(CH₂)ₒ—, —(CH₂CH₂O)ₚ—CH₂CH₂, —CH₂CH₂—S—CH₂CH₂— or —CH₂CH₂—NH—CH₂CH₂—, with o being an integer from 2 to 12 and p being an integer from 1 to 3.

Preferred spacer groups are ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyl-iminoethylene, 1-methylalkylene, ethenylene, propenylene and butenylene.

In another embodiment of the present invention the chiral compounds of formula I comprise at least one spacer group Sp that is a chiral group of the formula IV: 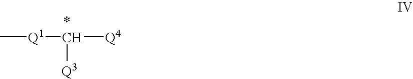
wherein

Q¹ and Q³ have the meanings given in formula III, and

Q⁴ is an alkylene or alkylene-oxy group with 1 to 10 C atoms or a single bond, being different from Q¹.

In the event that R is denoting P-Sp-X—, the two spacer groups Sp in the compounds of formula I may be identical or different.

Of the preferred compounds described above particularly preferred are those wherein n is 1.

Further preferred are compounds comprising both a group P-(Sp-X)ₙ— wherein n is 0 and a group P-(Sp-X)ₙ— wherein n is 1.

The compounds of formula I can be synthesized according to or in analogy to methods which are known per se and which are described in standard works of organic chemistry such as, for example, Houben-Weyl, Methoden der organischen Chemie, Thieme-Verlag, Stuttgart.

Examples of suitable polymerizable mesogenic compounds that can be used as components of the polymerizable liquid crystalline material, are disclosed for example in WO 93/22397 A1; EP 0 261 712 A1; DE 195 04 224 A1; WO 95/22586 A1 and WO 97/00600 A2. The compounds disclosed in these documents, however, are to be regarded merely as examples that shall not limit the scope of the present invention.

Preferably the polymerizable liquid crystalline mixture comprises at least one polymerizable mesogenic compound having one polymerizable functional group and at least one polymerizable mesogenic compound having two or more polymerizable functional groups.

Examples of especially useful monoreactive chiral and achiral polymerizable mesogenic compounds are shown in the following list of compounds, which should, however, be taken only as illustrative and is in no way intended to restrict, but instead to explain the present invention: 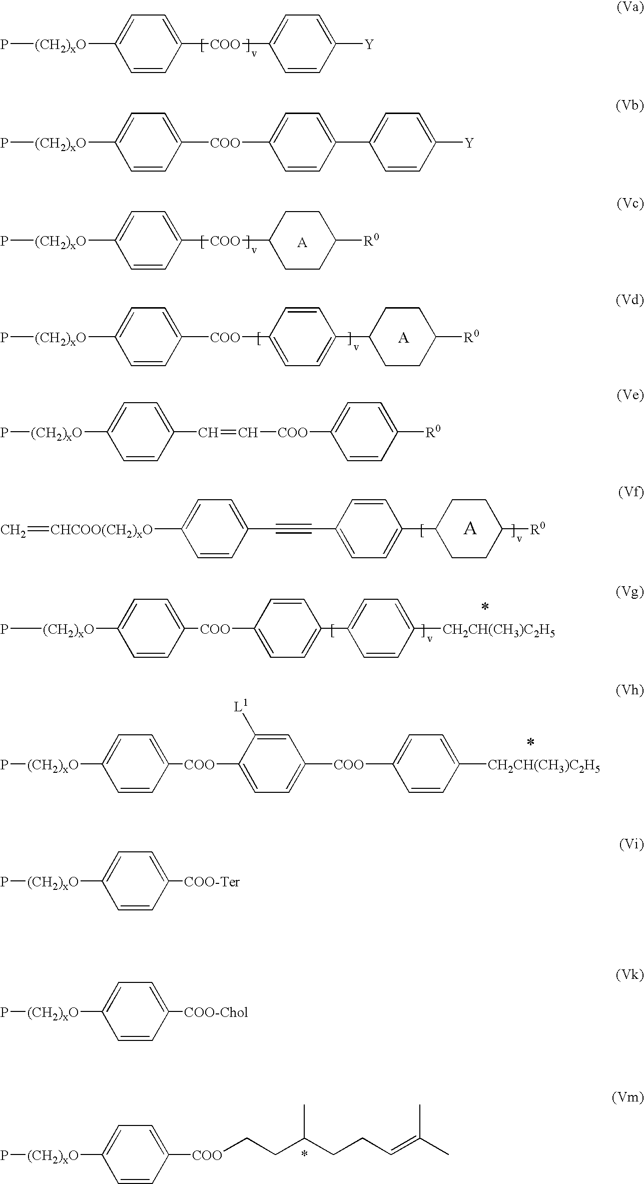
wherein, P has one of the meanings of formula I and its preferred meanings as mentioned above, x is an integer from 1 to 12 , A is 1,4-phenylene or 1,4-cyclohexylene, v is 0 or 1, Y has one of the meanings of the polar group R as defined above, R⁰ has one of the meanings of the non-polar group R as defined above, Ter is a terpenoid radical, like e.g. menthyl, Chol is a cholesteryl group, and L¹ is H, F, Cl, OH, CN, NO₂ or an optionally halogenated alkyl, alkoxy or carbonyl group with 1 to 7 C atoms.

In particular preferred are the polymerizable mesogenic compounds of formulae Va and Vc.

Examples of useful direactive chiral and achiral polymerizable mesogenic compounds are shown in the following list of compounds, which should, however, be taken only as illustrative and is in no way intended to restrict, but instead to explain the present invention: 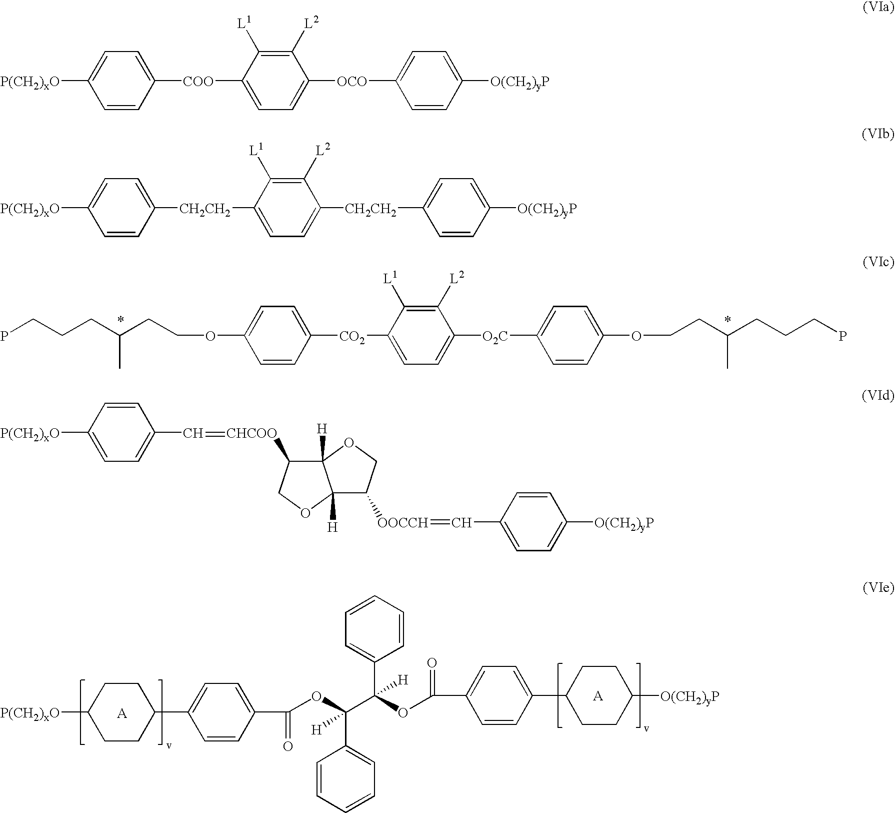
wherein, P has one of the meanings of formula I and its preferred meanings as mentioned above, x and y are each independently an integer from 1 to 12, A is 1,4-phenylene or 1,4-cyclohexylene, v is 0 or 1, and L¹ and L² are each independently H, F, Cl, OH, CN, NO₂ or an optionally halogenated alkyl, alkoxy or carbonyl group with 1 to 7 C atoms.

In particular preferred are the polymerizable mesogenic compounds of formula Vla.

A first preferred polymerizable liquid crystalline mixture comprises
a) 10 to 90% by weight, more preferably 25 to 75% by weight, of preferably up to five, more preferably two, three or four, monoreactive mesogenic compounds having a polar terminal group, and
b) 5 to 80% by weight, more preferably 10 to 65% by weight, of preferably up to four, more preferably one or two, direactive polymerizable mesogenic compounds.

A second preferred polymerizable liquid crystalline mixture comprises
a) 0 to 30% by weight, more preferably 0 to 5% by weight, of preferably up to five, more preferably one, two or three, monoreactive mesogenic compounds having a polar terminal group, and
b) 90% by weight or more, more preferably 90 to 99.5% by weight, of preferably up to four, more preferably one, two or three, direactive polymerizable mesogenic compounds.

Especially preferred mixtures of the second embodiment are those containing no monoreactive polymerizable compounds of component a).

A third preferred polymerizable liquid crystalline mixture comprises
a) 80% by weight or more, more preferably 90 to 99.5% by weight, of preferably up to five, more preferably two, three or four, monoreactive mesogenic compounds having a polar terminal group, and
b) 0 to 20% by weight, more preferably 0 to 5% by weight, of preferably up to four, more preferably one or two, direactive polymerizable mesogenic compounds.

Especially preferred mixtures of the third embodiment are those containing no direactive polymerizable compounds of component b).

A polymerizable liquid crystalline mixture according to another embodiment of the present invention comprises one or more chiral polymerizable mesogenic compounds. Preferably these compounds are selected from formula I, wherein MG, Sp and/or R are comprising a chiral moiety. More preferred are chiral compounds selected from the formulae Va to Vm disclosed above.

A further object of the present invention is to provide a method for the preparation of the barrier coating composition of the present invention, which is characterized in that

a) a polymerizable liquid crystalline mixture comprising one or more polymerizable mesogenic compounds is applied onto a substrate,

b) the polymerizable liquid crystalline mixture is aligned into a uniform orientation, and

c) the polymerizable liquid crystalline mixture applied and aligned onto the substrate is polymerized to give a liquid crystalline polymer and to permanently fix the orientation of the liquid crystalline mixture.

In the preferred embodiment the liquid crystalline polymer is not removed from the substrate, but it is possible to remove the liquid crystalline polymer from the substrate. In case the substrate is not removed from the liquid crystalline polymer, preferably an isotropic substrate is used.

As a substrate for example a glass or quarz sheet or a plastic film or sheet can be used.

If the substrate is a plastic substrate it is preferably a film of polyester, such as polyethyleneterephthalate (PET) or polynaphthaleneterepththalate (PEN), polyethylene (PE), polypropylene (PP), polyvinylidene chloride (PVDC), polyacrylate, polymethacrylate, polyurethane (PU), polyamide (PA), polyvinylalcohol (PVA), polycarbonate (PC), triacetylcellulose (TAC), epoxy resin, mercapto ester (e.g. Norland Optical Adhesive 73), liquid-crystalline polymer (LCP) and ORMOCER® (inorganic-organic hybrid polymer from the Fraunhofer-Gesellschaft).

Especially preferred are films of PET. It is also possible to use mixtures of two or more different polymeric materials. As a birefringent substrate for example an uniaxially stretched plastic film can be used.

Especially preferred are glass substrates, in particular covered with rubbed polyimide.

The polymerizable liquid crystalline mixture can also be dissolved in a solvent, preferably in an organic solvent. The solution is then coated onto the substrate, for example by spin-coating or other known techniques, and the solvent is evaporated off. In most cases it is preferred to heat the mixture in order to facilitate the evaporation of the solvent.

In addition to the methods described above, planar alignment in the coated layer of the polymerizable liquid crystalline mixture can further be enhanced by shearing the material, e.g. by means of a doctor blade. It is also possible to apply an alignment layer, for example a layer of rubbed polyimide or sputtered SiOₓ, on top of the substrate, or alternatively to directly rub the substrate, i.e. without applying an additional alignment layer.

For example rubbing can be achieved by means of a rubbing cloth, such as a velvet cloth, or with a flat bar coated with a rubbing cloth. In a preferred embodiment of the present invention rubbing is achieved by means of at least one rubbing roller, like e.g. a fast spinning roller that is brushing across the substrate, or by putting the substrate between at least two rollers, wherein in each case at least one of the rollers is optionally covered with a rubbing cloth. In another preferred embodiment of the present invention rubbing is achieved by wrapping the substrate at least partially at a defined angle around a roller that is preferably coated with a rubbing cloth.

Polymerization of the polymerizable liquid crystalline mixture is achieved for example by exposure to heat or actinic radiation. Actinic radiation means irradiation with light, like UV light, IR light or visible light, irradiation with X-rays or gamma rays or irradiation with high energy particles, such as ions or electrons. Preferably the polymerization is carried out by UV irradiation.

As a source for actinic radiation for example a single UV lamp or a set of UV lamps can be used. When using a high lamp power the polymerization time can be reduced. Another possible source for actinic radiation is a laser, like e.g. a UV laser, an IR laser or a visible laser.

The polymerization is carried out in the presence of an initiator absorbing at the wavelength of the actinic radiation. For example, when polymerizing by means of UV light, a photoinitiator can be used that decomposes under UV irradiation to produce free radicals or ions that start the polymerization reaction.

When polymerizing polymerizable mesogens with acrylate or methacrylate groups, preferably a radical photoinitiator is used, when polymerizing polymerizable mesogens with vinyl or epoxide groups, preferably a cationic photoinitiator is used.

It is also possible to use a polymerization initiator that decomposes when heated to produce free radicals or ions that start the polymerization.

As a photoinitiator for radical polymerization for example the commercially available Irgacure® 651, Irgacure® 184, Darocure® 1173 or Darocure® 4205 (all from Ciba Geigy AG) can be used, whereas in case of cationic photopolymerization the commercially available UVI 6974 (Union Carbide) can be used.

The polymerizable liquid crystalline mixture preferably comprises 0.1 to 10% by weight, more preferably 0.5 to 7% by weight and in particular 1 to 5% by weight of a polymerization initiator. UV photoinitiators are preferred, in particular radicalic UV photoinitiators.

The polymerization time is depending, inter alia, on the reactivity of the polymerizable mesogenic compounds, the thickness of the coated layer, the type of polymerization initiator and the power of the UV lamp. The polymerization time according to the present invention is preferably not longer than 10 minutes, more preferably not longer than 5 minutes and in particular shorter than 2 minutes. For mass production short polymerization times of 3 minutes or less, more preferably of 1 minute or less and in particular of 30 seconds or less, are preferred.

In addition to polymerization initiators the polymerizable liquid crystalline mixture may also comprise one or more other suitable components such as, for example, catalysts, stabilizers, chain-transfer agents and/or co-reacting monomers. In particular the addition of stabilizers is preferred in order to prevent undesired spontaneous polymerization of the polymerizable liquid crystalline mixture for example during storage.

As stabilizers in principal all compounds can be used that are known to the person skilled in the art for this purpose. These compounds are commercially available in a broad variety. Typical examples for stabilizers are 4-ethoxyphenol and butylated hydroxytoluene (BHT).

Other additives, like e.g. chain transfer agents, can also be added to the polymerizable liquid crystalline mixture in order to modify the physical properties of the polymer film. When adding a chain transfer agent, such as monofunctional thiol compounds, like e.g. dodecane thiol, or multifunctional thiol compounds, like e.g. trimethylpropane tri(3-mercaptopropionate), to the polymerizable liquid crystalline mixture, the length of the free polymer chains and/or the length of the polymer chains between two crosslinks in the polymer film can be controlled. When the amount of the chain transfer agent increases, the polymer chain length in the obtained polymer film decreases.

In another embodiment, the polymerizable liquid crystalline mixture preferably comprises 0.01 to 6% by weight, more preferably 0.1 to 3% by weight, of at least one surfactant. When the liquid crystalline mixture is coated onto a substrate, the surfactant reduces the tilt angle of the liquid crystal molecules in the barrier coating layer and thus enhance the planar alignment of the liquid crystalline mixture.

If the surfactant is a polymerizable surfactant component, it copolymerizes with the monomers of the liquid crystalline mixture, and is thus chemically bound into the forming polymer film. Thereby migration or phase separation of the surfactant are prevented.

In a further embodiment the polymerizable liquid crystalline mixture preferably comprises 0.1 to 15% by weight, more preferably 0.2 to 9% by weight, of one or more non-polymerizable chiral dopants.

Preferred are chiral dopants with a high helical twisting power (HTP), in particular those disclosed in WO 98/00428. Further typically used chiral dopants are e.g. the commercially available S 1011, R 811 or CB 15 (from Merck KGaA, Darmstadt, Germany).

It is also possible, in order to increase crosslinking of the polymers, to add up to 20% by weight of a non mesogenic compound with two or more polymerizable functional groups to the polymerizable liquid crystalline mixture alternatively or in addition to the di- or multifunctional polymerizable mesogenic compounds to increase crosslinking of the polymer.

Typical examples for difunctional non mesogenic monomers are alkyldiacrylates or alkyldimethacrylates with alkyl groups of 1 to 20 C atoms. Typical examples for non mesogenic monomers with more than two polymerizable groups are trimethylpropanetrimethacrylate or pentaerythritoltetraacrylate.

In another embodiment the polymerizable liquid crystalline mixture comprises up to 70% by weight, preferably up to 50% by weight of a non mesogenic compound with one polymerizable functional group. Typical examples for monofunctional non mesogenic monomers are alkylacrylates or alkylmethacrylates.

In a preferred embodiment of the invention the polymerization of the polymerizable liquid crystalline mixture is carried out under an atmosphere of inert gas, preferably under a nitrogen atmosphere.

The selection of suitable polymerization temperatures depends mainly on the clearing point of the polymerizable material and inter alia on the softening point of the substrate. Preferably the polymerization temperature is at least 30° C. below the clearing temperature of the polymerizable liquid crystalline mixture.

The liquid crystalline polymer is present in the barrier coating composition in an amount of 50 to 100% by weight, preferably in an amount of 70 to 100% by weight and more preferably in an amount of 90 to 100% by weight. In particular, the barrier coating composition consists of the liquid crystalline polymer.

In a further embodiment of the present invention the barrier coating composition comprises at least one inorganic flake material.

As inorganic flake material all materials which are known to a person skilled in the art and which are suitable for the purpose of the present application can be used. Preferred inorganic flake materials include mica, alumina, silica and glass. More preferably silica and glass are used as inorganic flake material. The most preferred inorganic flake material is glass.

The thickness of the inorganic flake material is preferably less than 1.0 μm, more preferably less than 0.5 μm and most preferably less than 0.3 μm.

The average particle size of the inorganic flake material is preferably in the range of 1 to 1000 μm and more preferably in the range of 50 to 500 μm. Preferred inorganic flake particles have an average particle size in the range of 100 to 400 μm and a thickness of 0.1 to 0.5 μm, preferably of 0.1 to 0.3 μm. The aspect ratio of the inorganic flakes is in the range of 20 to 5000, preferably in the range of 200 to 2000.

Optionally the inorganic flake particles can be coated with one or more layers selected from the group consisting of metal oxides, metal suboxides, metal fluorides, metal oxyhalides, metal chalcogenides, metal nitrides, metal carbides or mixtures thereof.

The inorganic flake material is preferably present in the barrier coating composition in an amount up to 50% by weight, more preferably in an amount up to 40% by weight and most preferably in an amount of up to 30% by weight.

The barrier coating composition of the present invention can be used in barrier coating layers of Organic Field effect transistors, Liquid crystal displays, OLED displays, flexible displays, displays of TV screens, photovoltaic cells, lithium batteries and any other application requiring a barrier against water and/or oxygen.

Furthermore, the barrier coating composition of the present invention can be used in barrier coating layers of food and medical packagings.

Furthermore, according to the present invention there is also provided a device, preferably a display, comprising a barrier coating layer, optionally on a substrate, characterized in that this layer comprises a barrier coating composition of the present invention. In a preferred embodiment, the barrier coating layer consists of the barrier coating composition of the present invention.

According to the present invention there is also provided a food and medical packaging comprising a barrier coating layer, which is characterized in that this layer comprises a barrier coating composition of the present invention. In a preferred embodiment, the barrier coating layer consists of the barrier coating composition of the present invention.

The barrier coating layer preferably has a thickness of 1 μm to 1000 μm, more preferably of 5 μm to 300 μm.

In a preferred embodiment, the barrier coating layer is transparent. Transparency is absolutely necessary especially for display applications where a viewer has to look through the barrier coating layer. If the barrier coating layer is on the reverse side of the display, or in applications such as lithium batteries or Organic Field effect transistors, then transparency is not a consideration. The transparency required for photovoltaic devices is not as high as for display applications.

The display of the present application can be prepared either in that the barrier coating composition is brought directly onto the substrate or in that the barrier coating composition is in a first step dispersed in an organic solvent, subsequent brought onto the substrate and finally the organic solvent is evaporated. Thereafter, the mixture is polymerized, preferably via UV irradiation.

Without further elaboration, it is believed that one skilled in the art can, using the preceding description, utilize the present invention to its fullest extent. The following examples are, therefore, to be construed as merely illustrative and not limitative of the remainder of the disclosure in any way whatsoever.

In the foregoing and in the following examples, unless otherwise indicated, all temperatures are set forth uncorrected in degrees Celsius and all parts and percentages are by weight.

### EXAMPLE 1

Preparation of calcium coated glass slides

Glass slides (25×25×1 mm) were prepared by ultrasonic washing in distilled water, acetone and isopropanol. The prepared slides were then transferred to a Braun glove box (H₂O<0.1 ppm, O₂<0.1 ppm). The slides were placed in a vacuum coating chamber of the Braun glove box and covered with a template. This template allowed the deposition of a 1×1 cm square in the middle of each slide. Deposition of calcium was conducted until a layer of 60 nm has been applied. A slide prepared in such a way was left in the glove box and showed no effect after 17 hours.

In a normal atmosphere such an uncoated sample reacted fully in 5 minutes.

### COMPARATIVE EXAMPLE 1

The calcium coated slides were then coated with a sample of Norland Optical Adhesive 73 in the following manner.

Ca. 1 g of this adhesive was applied to the centre of the slide. A silicone treated PET release layer was applied to the coating, a glass microscope slide placed on this and a 600 g weight applied to the glass slide. The mixture was left for 30 seconds.

The weight was removed and the slide was exposed to UV irradiation (EFOS lamp, 200 mW cm⁻²) for 30 seconds. The glass slide and release layer were removed and then further curing was performed for another 30 seconds.

This process gave a film thickness of 28 μm.

In a normal atmosphere such a coated sample slide reacted fully in 29 minutes.

### EXAMPLE 2

In the same way as in comparative example 1, calcium coated slides were coated with the following composition:

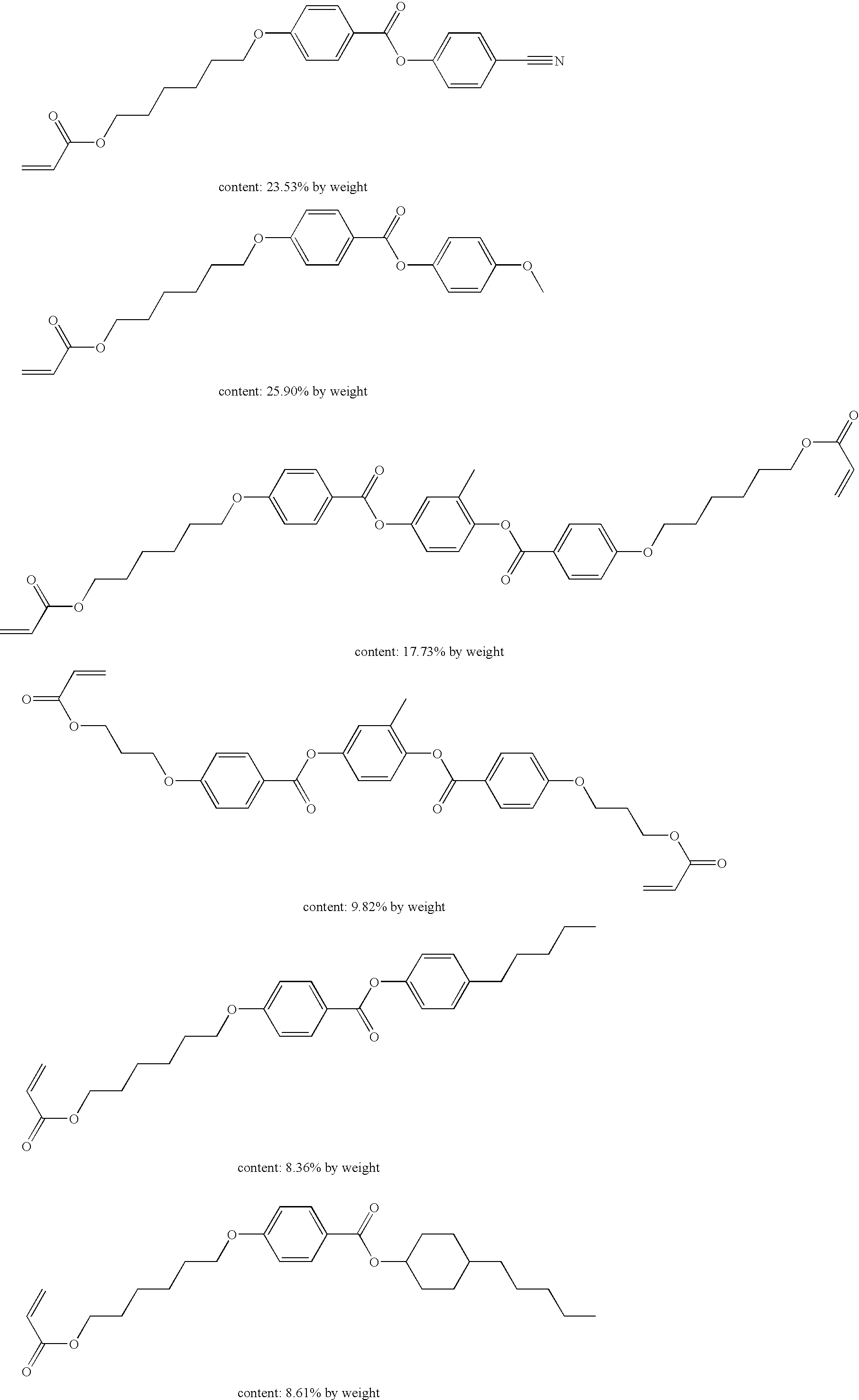

| | |
|---|---|
| Irgacure ® 907 | 5.68% by weight |
| Zonyl FSO | 0.38% by weight |

The calcium coated slides were then coated with a sample of the Liquid Crystal mixture in the following manner.

Ca. 1 g of the Liquid Crystal mixture was applied to the centre of the slide. A silicone treated PET release layer was applied to the coating, a glass microscope slide placed on this and a 600 g weight applied to the glass slide. The mixture was left for 30 seconds.

The weight was removed and the slide was exposed to UV irradiation (EFOS lamp, 200 mW cm⁻²) for 30 seconds. The glass slide and release layer were removed and then further curing was performed for another 30 seconds.

This process gave a film thickness of 32 μm.

In a normal atmosphere such a coated sample slide reacted fully in 92 minutes. The improvement with respect to the coating of comparative example 1 was appoximately 300%.

1. A barrier coating composition comprising a liquid crystalline polymer, characterized in that the liquid crystalline polymer is formed in that a polymerizable liquid crystalline mixture comprising one or more polymerizable mesogenic compounds is first applied onto a substrate and polymerized afterwards.

2. A barrier coating composition as claimed in claim 1, characterized in that the polymerizable mesogenic compounds of the polymerizable liquid crystalline mixture are selected of formula I
P-(Sp-X)ₙ-MG-R I
wherein
P is a polymerizable group,
Sp is a spacer group having 1 to 25 C atoms,
X is —O—, —S—, —CO—, —COO—, —OCO—, —CO—NH—, —NH—CO—, —CH₂CH₂—, —OCH₂—, —CH₂O—, —SCH₂—, —CH₂S—, —CH═CH—, —CH═CH—COO—, —OCO—CH═CH—, —C≡C— or a single bond,
n is 0 or 1,
MG is a mesogenic group, and
R is H, CN, NO₂, halogen or a straight-chain or branched alkyl radical with up to 25 C atoms which may be unsubstituted, mono- or polysubstituted by halogen or CN, it being also possible for one or more non-adjacent CH₂ groups to be replaced, in each case independently from one another, by
—O—, —S—, —NH—, —N(CH₃)—, —CO—, —COO—, —OCO—, —OCO—O—, —S—CO—, —CO—S— or —C≡C—, in such a manner that oxygen atoms are not linked directly to one another, or alternatively R is denoting P-(Sp-X)ₙ—.

3. A barrier coating composition as claimed in claim 2, characterized in that MG in formula I is selected of formula II
-A¹-Z¹-(A²-Z²-)ₘ-A³- II
wherein
Z¹ and Z² are each independently —COO—, —OCO—, —CH₂CH₂—, —OCH₂—, —CH₂O—, —CH═CH—, —CH═CH—COO—, —OCO—CH═CH—, —C≡C— or a single bond,
A¹, A² and A³ are each independently 1,4-phenylene in which, in addition, one or more CH groups may be replaced by N, 1,4-cyclohexylene in which, in addition, one or two non-adjacent CH₂ groups may be replaced by O and/or S, 1,4-cyclohexenylene, 1,4-bicyclo(2,2,2)octylene, piperidine-1,4-diyl, naphthalene-2,6-diyl, decahydronaphthalene-2,6-diyl or 1,2,3,4-tetrahydronaphthalene-2,6-diyl, it being possible for all these groups to be unsubstituted, mono- or polysubstituted with F, Cl, OH, CN, NO₂ or alkyl, alkoxy or alkanoyl groups having 1 to 7 C atoms wherein one or more H atoms may be substituted by F or Cl, and
m is 0, 1 or 2.

4. A barrier coating composition as claimed in claim 2, characterized in that the polymerizable group P in formula I is selected from 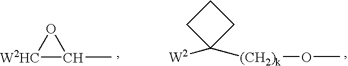
CH₂═CW¹—COO—, CH₂═CW²—O—, CH₃—CH═CH—O—, HO—CW²W³—, HS—CW²W³—, HW²N—, HO—CW²W³—NH—, CH₂═CW¹—CO—NH—, CH₂═CH—(COO)ₖ₁—Phe—(O)ₖ₂—, Phe-CH═CH—, HOOC—, OCN— and W⁴W⁵W⁶Si—, with W¹ being H, Cl, CN, phenyl or alkyl with 1 to 5 C-atoms, W² and W³ being independently of each other H or alkyl with 1 to 5 C-atoms, W⁴, W⁵ and W⁶ being independently of each other Cl, oxaalkyl or oxacarbonylalkyl with 1 to 5 C-atoms, Phe being 1,4-phenylene, k is an integer from 1 to 12 and k₁ and k₂ being independently of each other 0 or 1.

5. A barrier coating composition as claimed in claim 2, characterized in that the spacer group Sp is a linear or branched alkylene group having 1 to 20 C atoms, in which, in addition, one or more non-adjacent CH₂ groups may be replaced by —O—, —S—, —NH—, —N(CH₃)—, —CO—, —O—CO—, —S—CO—, —O—COO—, —CO—S—, —CO—O—, —CH(halogen)-, —CH(CN)—, —CH═CH— or —C≡C—.

6. A barrier coating composition as claimed in claim 2, characterized in that R in formula I denotes P-(Sp-X)ₙ—.

7. A barrier coating composition as claimed in claim 2, characterized in that the polymerizable liquid crystalline mixture comprises at least one polymerizable mesogenic compound having one polymerizable functional group and at least one polymerizable mesogenic compound having two or more polymerizable functional groups.

8. A method for the preparation of a barrier coating composition as claimed in claim 1, characterized in that a) a polymerizable liquid crystalline mixture comprising one or more polymerisable mesogenic compounds is applied onto a substrate,
b) the polymerizable liquid crystalline mixture is aligned into a uniform orientation, and
c) the polymerizable liquid crystalline mixture applied and aligned onto the substrate is polymerized to give a liquid crystalline polymer and to permanently fix the orientation of the liquid crystalline mixture.

9. The use of a barrier coating composition as claimed in claim 1 in barrier coating layers of Organic Field effect transistors, Liquid crystal displays, OLED displays, flexible displays, displays of TV screens, photovoltaic cells and lithium batteries.

10. he use of a barrier coating composition as claimed in claim 1 in barrier coating layers of food and medical packagings.

11. A device comprising a barrier coating layer, characterized in that this layer comprises a barrier coating composition as claimed in claim 1.

12. A display comprising a barrier coating layer, characterized in that this layer comprises a barrier coating composition as claimed in claim 1.

13. Food packaging having a barrier coating layer, characterized in that this layer comprises a barrier coating composition as claimed in claim 1.

14. Medical packaging having a barrier coating layer, characterized in that this layer comprises a barrier coating composition as claimed in claim 1.
